(19) United States
(12) Patent Application Publication
(10) Pub. No.: US 2026/0044364 A1
(43) Pub. Date: Feb. 12, 2026

(54) Dynamic Task Resource Allocation Using Meta-Learning Diagnostic Models

(71) Applicant: Bank of America Corporation, Charlotte, NC (US)

(72) Inventors: JayaBalaji Murugan, Chennai (IN); Rajagopal Kesavan, Chennai (IN); Rishekumar Muthukrishnan, Chennai (IN)

(21) Appl. No.: 18/749,719

(22) Filed: Jun. 21, 2024

(51) Int. Cl. G06F 9/48

(52) U.S. Cl. CPC G06F 9/4837; G06F 9/485; G06F 2209/483

(57) ABSTRACT

Aspects of the disclosure related to dynamic task resource allocation. A computing platform may train a payload model using historical task information to determine whether a task contains a heavy payload. The computing platform may receive task information corresponding to a task. The computing platform may preprocess the task information. The computing platform may input the preprocessed task information into the trained payload model. The computing platform may extract a CPU percentage and throughput associated with the preprocessed task information. The computing platform may compare the CPU percentage to a CPU percentage threshold and the throughput to a throughput threshold. The computing platform may preempt a task corresponding to the task information based on both thresholds being exceeded.

### BACKGROUND

Aspects of the disclosure related to one or more systems that execute tasks using a particular resource allocation (e.g., memory, processors, etc). In some instances, certain tasks might not be well-suited to be executed using an existing resource allocation. This may lead to long execution times and/or other related issues. Accordingly, it may be important to identify tasks that might not have a resource allocation that is well-suited to execute the identified tasks.

### SUMMARY

Aspects of the disclosure provide effective, scalable, and convenient technical solutions that address and overcome the technical problems associated with dynamic task resource allocation. In accordance with one or more embodiments of the disclosure, a computing platform comprising at least one processor, a communication interface, and memory storing computer-readable instructions may train, based on historical task information, a payload model, in which training the payload model may configure the payload model to identify whether a task includes a heavy payload. The computing platform may receive, from a task execution system, first task information corresponding to a first task. The computing platform may preprocess the first task information. The computing platform may input the preprocessed first task information into the trained payload model. The computing platform may extract a central processing unit (CPU) percentage and a throughput in the preprocessed first task information corresponding to the first task. The computing platform may compare the CPU percentage to a CPU percentage threshold. The computing platform may compare the throughput to a throughput threshold. The computing platform may, based on identifying that both the CPU percentage threshold and the throughput threshold being exceeded, send commands to the task execution system, that when received, may direct the task execution system to preempt the first task, in which the preempting may include one of queuing the first task or interrupting the first task.

In one or more examples, the preprocessing may further include using a raw zone, a stage zone, and a hub zone to preprocess the first task information. In some instances, the computing platform may update the payload model using a dynamic feedback loop and based on one or more of: the extracting, the comparing the CPU percentage to the CPU percentage threshold, or the comparing the throughput to the throughput threshold, the payload model.

In one or more example, the payload model may be a Naïve Bayes classification model. In some instances, the training may further include generating a frequency table, in which the frequency table may include the historical task information that was used to train the payload model and generating a likelihood table, in which the likelihood table may include a classifier and threshold information.

In one or more examples, the computing platform may, based on the CPU percentage threshold or the throughput threshold being exceeded, send an indication, that when received by an enterprise user device, may notify the enterprise user device that one or more of the CPU percentage threshold or the throughput threshold has been exceeded.

In some instances, the computing platform may input, into an actuator engine, the first task information associated with the first task that contains a heavy payload. In one or more examples, the computing platform may use the actuator engine to identify an updated resource allocation associated with the first task.

In some instances, the computing platform may generate a report, in which the report may include the updated resource allocation and the first task information. In one or more examples, the computing platform may send, to an enterprise user device, the report and one or more commands directing the enterprise user device to display the report, which may cause the enterprise user device to display the report.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for dynamic task resource allocation in accordance with one or more aspects described herein;

FIGS. 2A-2F depict an illustrative event for dynamic task resource allocation in accordance with one or more aspects described herein;

FIGS. 3-5 depict illustrative methods for dynamic task resource allocation in accordance with one or more aspects described herein;

FIG. 6 depicts an illustrative block diagram for dynamic task resource allocation in accordance with one or more aspects described herein; and

FIG. 7 depicts an illustrative graphical user interface for dynamic task resource allocation in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to dynamic task resource allocation using meta-learning diagnostic models (within, e.g., data lake platforms). Existing resource allocation methods within computing clusters may lack the needed adaptability and accuracy for efficient management of diverse job payloads. Inadequate utilization of historical data and intricate job behavior patterns may result in suboptimal resource allocation and prolonged job execution times. A compelling requirement may exist for a novel and comprehensive approach that may surpass the limitations of current resource allocation strategies. The inherent unpredictability of incoming job payloads, combined with varying workload demands, may pose a significant challenge. Accurately predicting the precise resource requirements for these diverse job characteristics may become complex as a result.

Accordingly, described herein is a system that may include an active meta-learning integration system that may enable a model to adapt and evolve based on various algorithms and historical data. In some instances, the self-evolving nature may enhance the predictive accuracy and adaptability over time, which may set the system apart from static systems. Dynamic algorithm selection may empower the model to intelligently choose the most suitable algorithm for each job/task. The system may adapt to diverse scenarios, which may reduce reliance on manual algorithm selection and differentiating from traditional methods.

Accordingly, a meta-learning model may incorporate new information over time to enhance the system's performance. The system may train the model to recognize a decline in prediction accuracy and automatically trigger a self-improvement process through retraining. The system may develop and fine-tune algorithms and strategies based on changing job patterns and cluster dynamics. The system may adapt to evolving job patterns and cluster conditions, thriving in dynamic environments. The system may outperform static allocation methods that may struggle to accommodate changes and variations.

These and other features are described in further detail below.

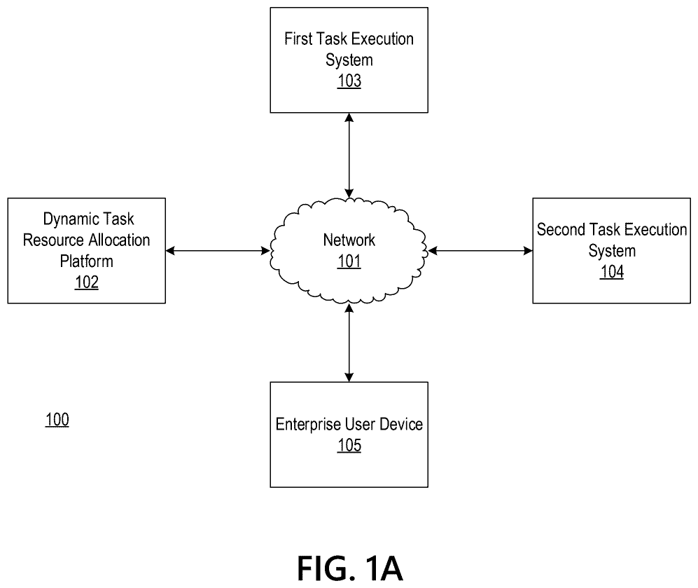

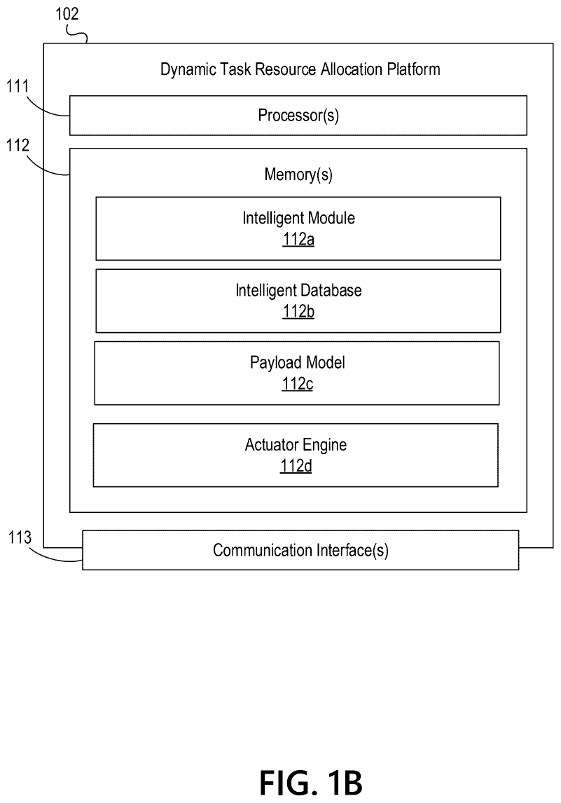

FIGS. 1A-1B depict an illustrative computing environment for dynamic task resource allocation in accordance with one or more aspects described herein. Referring to FIG. 1A, computing environment 100 may include one or more computer systems. For example, computing environment 100 may include dynamic task resource allocation platform 102, task execution system 103, task execution system 104, and enterprise user device 105.

As described further below, dynamic task resource allocation platform 102 may be a computer system that includes one or more computing devices (e.g., servers, server blades, or the like) and/or other computer components (e.g., processors, memories, communication interfaces) that may be used to train, host, and/or otherwise refine a payload model and/or an actuator engine, which may be used to detect the presence of a heavy payload in a task and dynamically reconfigure the resources associated with the task based on the task containing a heavy payload.

First task execution system 103 and/or second task execution system 104 may be or include one or more computing devices (e.g., servers, server blades, or the like) and/or computer components (e.g., processors, memories, communication interfaces, and/or other components). In some instances, first task execution system 103 and/or second task execution system 104 may each execute a plurality of tasks, store historical task information, and/or perform other functions. In some instances, first task execution system 103 and/or second task execution system 104 may be configured as a cloud storage system, in which first task execution system 103 and/or second task execution system 104 may be a cloud computing model that stores information on the Internet through a cloud computing provider who manages and operates first task execution system 103 and/or second task execution system 104 as a service. In some instances, first task execution system 103 and/or second task execution system 104 may be local or non-cloud based storage, such as a backend server or database associated with an enterprise organization (e.g., a financial institution). In some instances, first task execution system 103 and/or second task execution system 104 may support cloud based storage. Although only two task execution systems are depicted (e.g., first task execution system 103 and second task execution system 104), additional or fewer task execution systems may be included without departing from the scope of the disclosure.

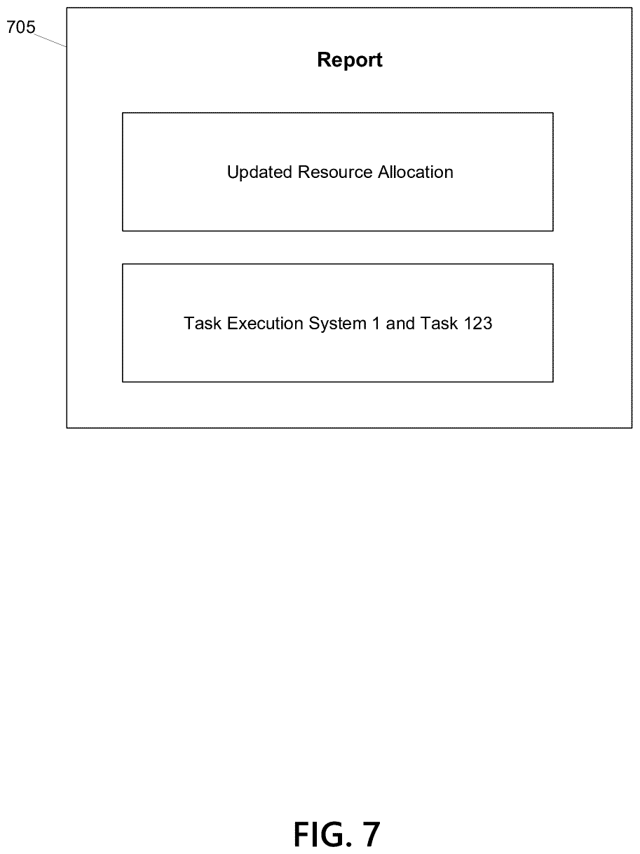

Enterprise user device 105 may be and/or otherwise include a laptop computer, desktop computer, mobile device, tablet, smartphone, server, server blade, and/or other device that may be configured to receive and/or display a report (e.g., including information about an updated resource allocation for a task being executed on first task execution system 103 and/or second task execution system 104) using one or more user interfaces (e.g., FIG. 7), on behalf of an enterprise organization, such as a financial institution.

Computing environment 100 also may include one or more networks, which may interconnect dynamic task resource allocation platform 102, first task execution system 103, second task execution system 104, and/or enterprise user device 105. For example, computing environment 100 may include a network 101 (which may interconnect, e.g., dynamic task resource allocation platform 102, first task execution system 103, second task execution system 104, and/or enterprise user device 105).

In one or more arrangements, dynamic task resource allocation platform 102, first task execution system 103, second task execution system 104, and/or enterprise user device 105 may be any type of computing device capable of sending and/or receiving requests and processing the requests accordingly. For example, dynamic task resource allocation platform 102, first task execution system 103, second task execution system 104, and/or enterprise user device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of dynamic task resource allocation platform 102, first task execution system 103, second task execution system 104, and/or enterprise user device 105 may, in some instances, be special-purpose computing devices configured to perform specific functions.

Referring to FIG. 1B, dynamic task resource allocation platform 102 may include one or more processors (e.g., processor 111), memory 112, and a communication interface (e.g., communication interface 113)). A data bus may interconnect the processor 111, memory 112, and communication interface 113. Communication interface 113 may be a network interface configured to support communication between dynamic task resource allocation platform 102 and one or more networks (e.g., network 101, or the like). Communication interface 113 may be communicatively coupled to the processor(s) 111. The memory may include one or more program modules having instructions that when executed by processor(s) 111 cause dynamic task resource allocation platform 102 to perform one or more functions described herein and/or one or more databases that may store and/or otherwise maintain information which may be used by such program modules and/or processor(s) 111. In some instances, the one or more program modules and/or databases may be stored by and/or maintained in different memory units of dynamic task resource allocation platform 102 and/or by different computing devices that may form and/or otherwise make up dynamic task resource allocation platform 102. For example, the memory may have, host, store, and/or include intelligent module 112a, intelligent database 112b, payload model and/or actuator engine 112d.

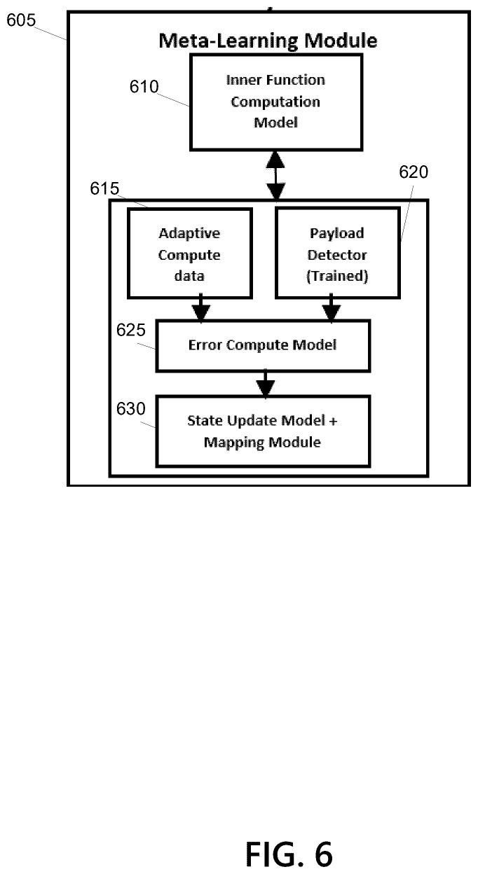

Intelligent module 112a may have instructions that direct and/or cause dynamic task resource allocation platform 102 to detect a heavy payload in a task and/or determine an updated resource configuration for a task containing a heavy payload, as discussed in greater detail below. Intelligent database 112b may have instructions and/or data used by intelligent module 112a, and/or dynamic task resource allocation platform 102 to store information used by intelligent module 112a and/or dynamic task resource allocation platform 102 in detecting a heavy payload, determining an updated resource configuration, and/or performing other functions. Payload model 112c may implement, refine, train, maintain, and/or otherwise host a machine learning model, that may be used to detect a task with a heavy payload using historical task information, and/or perform other methods described herein. Actuator engine 112d may implement, refine, train, maintain, and/or otherwise host an artificial intelligence (AI) model (e.g., a meta-learning model, such as what is shown in FIG. 6), that may be used to determine an updated resource configuration for a task containing a heavy payload using historical task information, and/or perform other methods described herein.

In some instances, the payload model 112c and/or the actuator engine 112d may utilize a supervised learning model/engine, which may utilize labeled inputs and outputs to perform the training. Using labeled inputs and outputs, the payload model 112c and/or the actuator engine 112d may measure its accuracy and learn over time. For example, supervised learning techniques such as linear regression, classification, neural networking, and/or other supervised learning techniques may be used.

Additionally or alternatively, the payload model 112c and/or the actuator engine 112d may utilize unsupervised learning, in which unlabeled data may be input into the payload model 112c and/or the actuator engine 112d. For example, unsupervised learning techniques such as k-means, gaussian mixture models, frequent pattern growth, and/or other unsupervised learning techniques may be used. In some instances, the payload model 112c and/or the actuator engine 112d may be a combination of supervised and unsupervised learning.

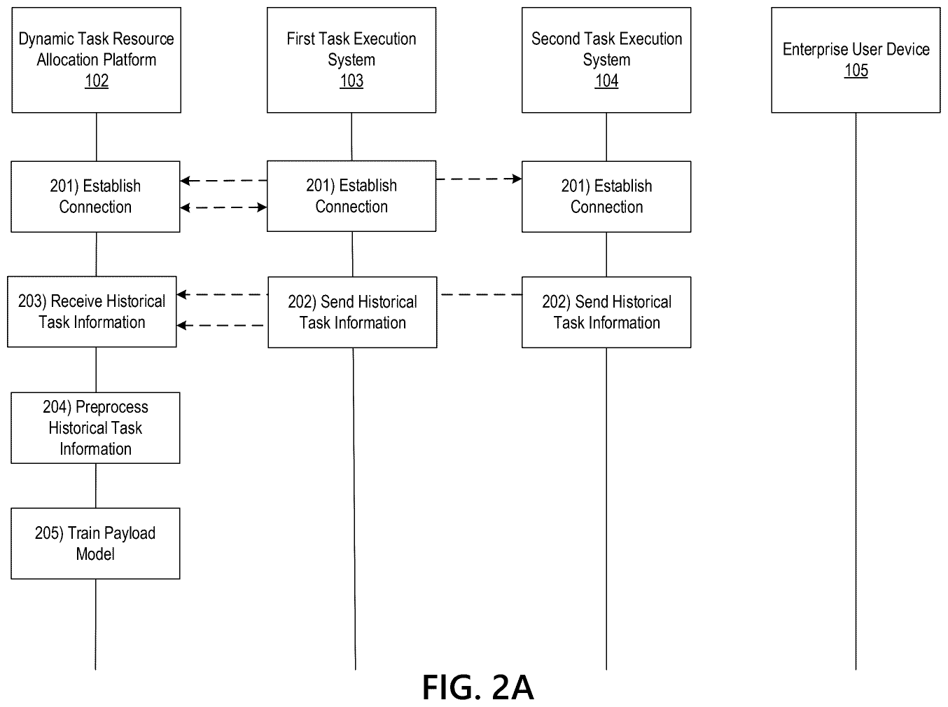

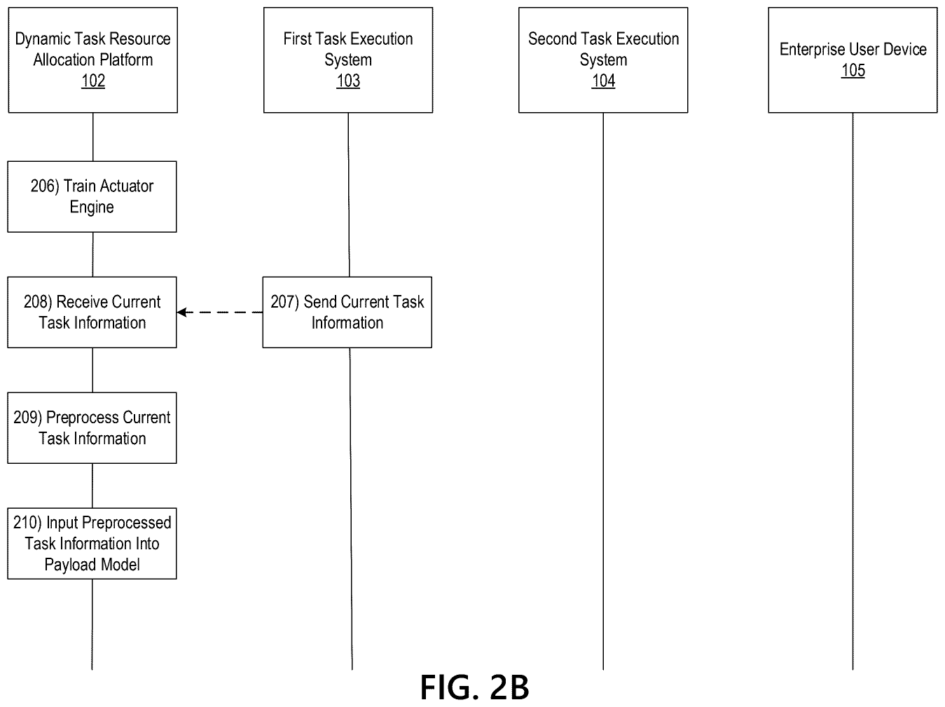

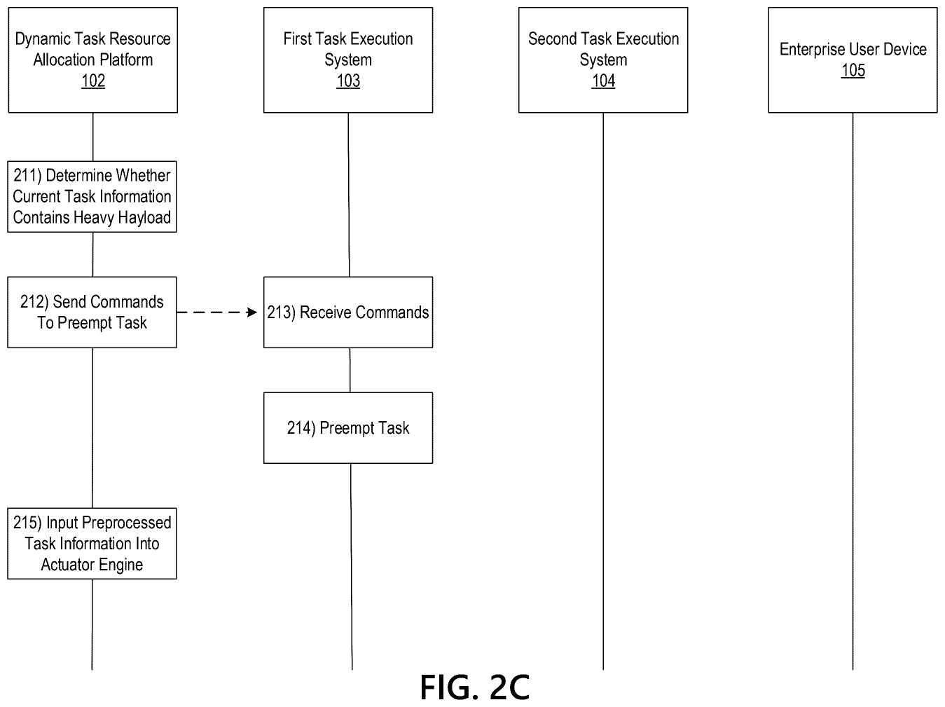

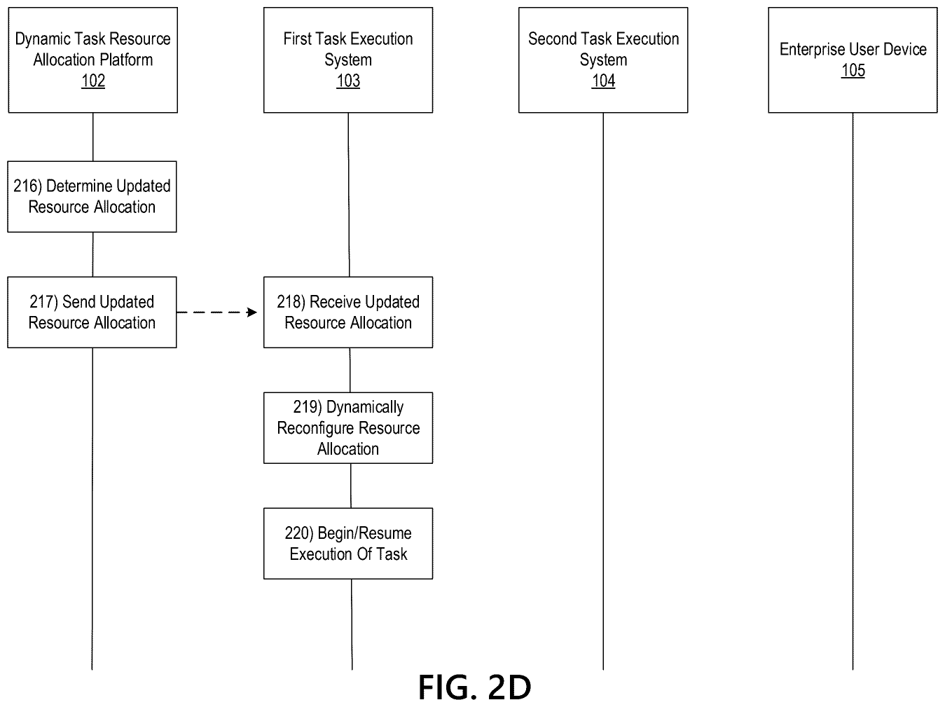

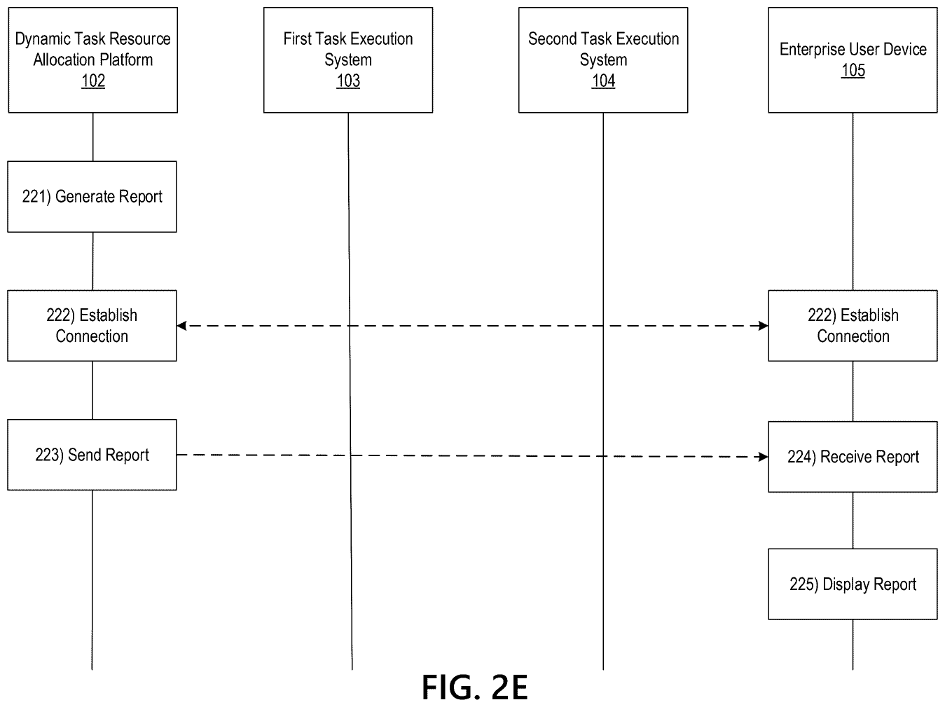

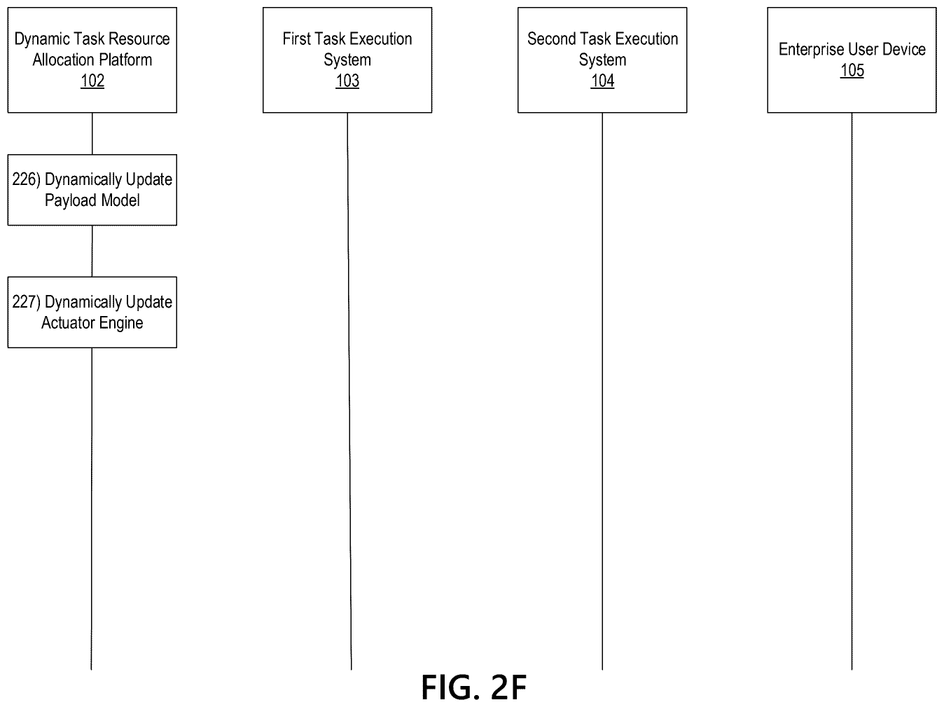

FIGS. 2A-2F depict an illustrative event sequence for dynamic task resource allocation in accordance with one or more aspects described herein. Referring to FIG. 2A, at step 201, first task execution system 103 and/or second task execution system 104 may establish a connection with dynamic task resource allocation platform 102. For example, first task execution system 103 and/or second task execution system 104 may establish a first wireless data connection with dynamic task resource allocation platform 102 to link first task execution system 103 and/or second task execution system 104 to dynamic resource allocation platform 102 (e.g., in preparation for sending historical task information). In some instances, first task execution system 103 and/or second task execution system 104 may identify whether or not a connection is already established with dynamic task resource allocation platform 102. If a connection is already established with dynamic resource allocation platform 102, first task execution system 103 and/or second task execution system 104 might not re-establish the connection. If a connection is not already established with dynamic task resource allocation platform 102, first task execution system 103 and/or second task execution system 104 may establish the first wireless data connection as described herein.

At step 202, first task execution system 103 and/or second task execution system 104 may send historical task information to dynamic task resource allocation platform 102. For example, first task execution system 103 and/or second task execution system 104 may send the historical task information using the first wireless data connection and via communication interface 113. Although described with reference to first task execution system 103 and second task execution system 104, one of first task execution system 103 or second task execution system 104 may individually send historical task information to dynamic task resource allocation platform 102, or additional task execution systems may similarly send historical task information to dynamic task resource allocation platform 102 without departing from the scope of the disclosure.

At step 203, dynamic task resource allocation platform 102 may receive the historical task information. For example, dynamic task resource allocation platform 102 may receive the historical task information using the first wireless data wireless and via communication interface 113. For example, the historical task information may include metadata and/or system logs related to information about previously executed tasks (e.g., historical tasks), which may include a length of time a task took to be completed, whether or not the task crashed, the central processing unit (CPU) percentage (e.g., the CPU utilization), the throughput, the resource allocation/configuration (e.g., the memory, number of cores/processors, number of executors, random access memory (RAM)), delta load factor, and/or other similar information. In this manner, dynamic task resource allocation platform 102 may receive a wide range of information about historical tasks, that may be used in furtherance of performing the functions described herein.

At step 204, dynamic task resource allocation platform 102 may preprocess the historical task information. For example, the historical task information may be preprocessed using three stages/zones. The first stage, which may be referred to as a RAW ZONE, may receive the historical task information and aggregate the historical task information from first task execution system 103, second task execution system 104, and/or other similar systems. In this manner, dynamic task resource allocation platform 102 may receive and aggregate the historical task information from a variety of different task executing systems in a raw data format.

The second stage, which may be referred to as a STAGE ZONE, may normalize the aggregated historical task information from the RAW ZONE. In some instances, this may include cleansing, validating, and/or curing the information. In some instances, this may include performing initial data quality checks (which may include, e.g., ensuring the data is current, accurate, and complete). In this manner, dynamic task resource allocation platform 102 may normalize the historical task information and create data sets that are consistent and uniform, regardless of the source of the historical task information, which may put the historical task information into a semiprocessed form.

The third stage, which may be referred to as a HUB ZONE, may analyze the normalized historical task information and determine whether the normalized historical task information is ready to be used in training the payload model 112c and/or the actuator engine 112d. Ensuring that the normalized historical task information is ready to be used in training the payload model 112c and/or the actuator engine 112d may include, for example, analyzing the normalized historical task information to identify any non-compliant activities/data within the normalized historical task information. In some instances, the HUB ZONE may also utilize change data capture (CDC). In this manner, dynamic task resource allocation platform 102 may create high quality and curated information that may be refined, cleaned, and integrated.

In some instances, in preprocessing the historical task information, dynamic task resource allocation platform 102 may determine whether private information is contained within the normalized historical task information (during e.g., the STAGE ZONE). Based on detecting private information within the historical task information (e.g., an individual's name, date of birth, social security number, etc.), dynamic task resource allocation platform 102 may remove that private information before proceeding to the next steps. In some instances, dynamic task resource allocation platform 102 may proceed back to the STAGE ZONE in order to remove the private information without departing from the scope of the disclosure. In this manner, historical task information may be preprocessed such that the historical task information may be used to perform the functions described herein (e.g., training the payload model 112c and/or the actuator engine 112d).

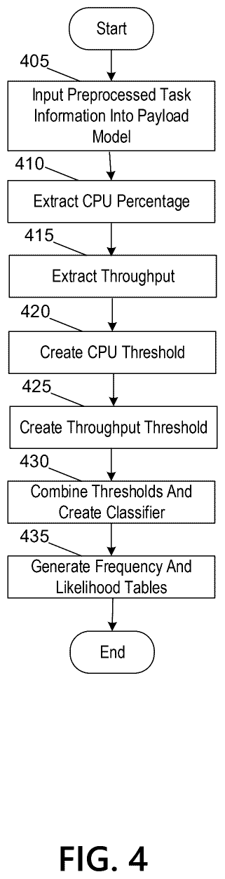

At step 205, dynamic task resource allocation platform 102 may train a payload model (e.g., payload model 112c) using the preprocessed historical task information. The payload model 112c may be trained to detect the presence of a heavy payload in a task. A heavy payload may refer to a task that may consume a significant amount (e.g., above a threshold amount) of network/computing resources, which may cause long execution times and/or other related issues. For example, the training may be similar to what is shown in FIG. 4. With reference to FIG. 4, at step 405, a computing platform (e.g., dynamic task resource allocation platform 102) having at least one processor, a communication interface, and memory may input preprocessed task information into the payload model 112c. For example, the preprocessed task information may be similar to the output described in step 204 (e.g., preprocessing the historical task information using the RAW ZONE, STAGE ZONE, and HUB ZONE).

At step 410, the computing platform may extract CPU percentage from the preprocessed task information. CPU percentage may refer to a utilization percentage of the processor(s) that supported executing a historical task. For example, a higher CPU percentage (e.g., greater than 25%) may indicate the presence of a heavy payload. At step 415, the computing platform may extract throughput of a historical task. Throughput may refer to a ratio of an amount of information that is transmitted and received when the previous task was executed (e.g., total bytes transmit rate/total bytes receive rate). For example, a lower throughput (e.g., less than 1) may indicate the presence of a heavy payload.

At step 420, the computing platform may create a CPU threshold based on the historical CPU percentages extracted from the historical tasks. For example, a CPU threshold may be 25% (representing, e.g., a high utilization). In some instances, the CPU threshold may be manually created by, for example, enterprise user device 105. In some instances, the CPU threshold may be automatically created using the payload model 112c. Although described using a CPU threshold of 25%, additional CPU thresholds (e.g., a CPU threshold of 10%, representing a medium utilization) may be used without departing from the scope of the disclosure.

At step 425, the computing platform may create a throughput threshold based on the historical throughputs extracted from the historical tasks. For example, a throughput threshold may be 1. In some instances, the throughput threshold may be manually created by, for example, enterprise user device 105. In some instances, the throughput threshold may be automatically created using the payload model. Although described using a throughput threshold of 1, different thresholds may be used without departing from the scope of the disclosure.

At step 430, the computing platform may combine the thresholds and create a classifier, which may be used to detect whether or not a task contains a heavy payload. For example, the classifier may include a CPU threshold of 25% and a throughput threshold of 1. In this manner, dynamic task resource allocation platform 102 may configure the payload model 112c to detect the presence of a heavy payload in any given task. In some instances, the payload model 112c may utilize a classification model, such as a Naïve Bayesian classification model. The Naïve Bayesian classification model may be based on the following:

$$P ( c \vert x ) = ( P ( x \vert c ) * P ( c ) ) / P ( x ) \qquad ( 1 )$$

The Naïve Bayesian classification model described in Equation (1) may detect a heavy payload based on an assumption that a predictor (x) in a given class (c) is independent of the values of other predictors.

At step 435, the computing platform may generate frequency and/or likelihood tables. A frequency table may include all the previous historical information that was used to train the payload model 112c. In some instances, the frequency table may include metrics such as historical CPU percentages and/or historical throughputs without departing from the scope of the disclosure. A likelihood table may include the classifier and/or threshold information (e.g., the CPU threshold and/or the throughput threshold), which may be applied to a future task in order to determine whether the task includes a heavy payload. In some instances, the likelihood table may consist of a probable outcome of a heavy payload, and based on the outcome of the likelihood table, a heavy payload may be detected without departing from the scope of the disclosure. The frequency table and/or the likelihood table may be stored at the payload model 112c, or at a database associated with the payload model (e.g., intelligent database 112b) without departing from the scope of the disclosure.

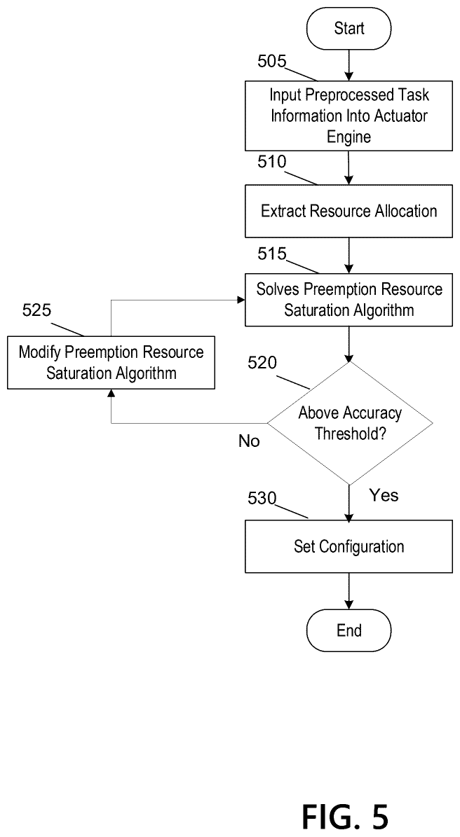

Returning to the illustrative event sequence and in reference to FIG. 2B, at step 206, dynamic task resource allocation platform 102 may train an actuator engine (e.g., actuator engine 112d). For example, the training may be similar to what is shown in FIG. 5. With reference to FIG. 5, at step 505, a computing platform (e.g., dynamic task resource allocation platform 102) having at least one processor, a communication interface, and memory may input preprocessed task information into an actuator engine. For example, the preprocessed task information may be similar to the output in step 204 (e.g., preprocessing the historical task information using the RAW ZONE, STAGE ZONE, and HUB ZONE).

At step 510, the computing platform may extract a resource allocation associated with the preprocessed task information. Resource allocation may refer to the configuration within, for example, first task execution system 103, which previously executed a task associated with the preprocessed task information. In some instances, the configuration may also be referred to as a cluster, which may contain a certain amount of processors, memory, etc. In some instances, the cluster may execute one or more tasks. In some instances, first task execution system 103 may contain one or more clusters executing a plurality of different tasks. In some instances, first task execution system 103 may execute tasks of a certain application (i.e., a big data application). In some instances, second task execution system 104 and/or other systems may similarly execute tasks of a different application (i.e., back-end, financial services, etc) without departing from the scope of the disclosure.

For example, a task being executed on a cluster may include a particular number of cores in the cluster (e.g., processors), a number of executors in the cluster, a RAM overhead, disk I/O space, storage memory, cache memory, programming memory, delta load factor, etc, and this may be associated with information that pertains to the execution of tasks.

At step 515, the computing platform may solve a preemption resource saturation (PRS) algorithm. A PRS algorithm may refer to an equation and/or model that may be solved in order to identify an optimal resource allocation that is better than the previous resource allocation (e.g., would reduce an amount of time the task may take to be executed). In some instances, the PRS algorithm may utilize a linear regression model. For example, the PRS algorithm may be an equation with fixed independent variables that may be used to solve for dependent variables. For example, the independent variables may be memory limit, cores limit, RAM allocated, disk I/O, storage memory, cache memory, processing memory, delta load factor, and/or other variables. The dependent variables may be one or more of disk space, cores, and/or RAM. In some instances, the PRS algorithm may be based on the following:

$$Y = X 1 + X 2 + X 3 + X 4 + X 5 + X 6 + X 7 + X 8 + X 9 + X 10 \qquad ( 2 )$$

$$Y = ( Disk Space , RAM allocated , CPU Memory , CPU Cores ) \qquad ( 3 )$$

Equation (2) may refer to how each of the independent variables (denoted by variables X1-X10) may be used to solve for Y, which may represent one or more dependent variables that may be used to update the resource allocation. Equation (3) may refer to one or more of the dependent variables that may be used to update the resource allocation. In this manner, the PRS algorithm may use the independent variables in an equation to solve for one or more dependent variables, which may represent an updated resource allocation.

At step 520, the computing platform may determine whether the solution is above an accuracy threshold (e.g., 85%). If the solution is above the accuracy threshold, then the computing platform may proceed to step 530. If the accuracy threshold is not met, then the computing platform may proceed to 525. In some instances, the accuracy of the solution may be determined by resubmitting/executing the task with the updated resource allocation and compared to that task with the original resource allocation without departing from the scope of the disclosure.

At step 525, the computing platform may modify the PRS algorithm based on the accuracy threshold not being exceeded. The PRS algorithm may be modified by changing the type of equation used, the independent variables, which dependent variables are solved, etc. In this manner the computing platform may train the actuator engine 112d to determine which algorithm is best suited for any particular task. For example, tasks from different task executing systems (e.g., from first task execution system 103 or second task execution system 104) may need to utilize different algorithms to determine an updated resource configuration that is above the accuracy threshold. In this manner, the actuator engine 112d may be configured as a meta-learning model/engine, which may adapt to different types of tasks coming from different task executing systems.

The actions performed in step 525 may be performed using the system described in FIG. 6. With reference to FIG. 6, meta-learning module 605 may include an inner function computation model 610, adaptive compute data 615, trained payload detector 620, error compute model 625, and/or state update model and mapping module 630. Inner function computation model 610 may represent the core model for the meta-learning module 605, which may contain and/or solve the PRS algorithm to determine an updated resource configuration. Adaptive compute data 615 may be used to adapt and/or otherwise update the meta-learning module 605 in response to receiving new task information and using different/updated algorithms in response to receiving the new task information. Trained payload detector 620 may be similar to payload model 112c. Error compute model 625 may be used to determine task errors and/or to support the actions performed in step 520. State update model and mapping module 630 may be an internal representation of a state of meta-learning module 605, which may be updated based on changes made to meta-learning module 605. In some instances, meta-learning module 605 may be included in the actuator engine 112d, or be a standalone module similar to the actuator engine 112d without departing from the scope of the disclosure.

At step 530, the computing platform may set the configuration of the updated resource allocation based on the accuracy threshold being exceeded. The configuration of the updated resource allocation may be set by using the solution of the PRS algorithm (e.g., the solution of Equation (2) and/or Equation (3)) to modify the current resource allocation to become the update resource allocation. In some instances, a deviation (using, e.g., a diagnostic quota sheet) may be added as part of the setting the configuration of the updated resource allocation. Additionally or alternatively, long pending and long running tasks (e.g., longer than 24 hours) may be monitored and/or suspended without departing from the scope of the disclosure.

Returning to FIG. 2B, at step 207, after dynamic task resource allocation platform 102 trains the actuator engine 112d, first task execution system 103 may send current task information to dynamic task resource allocation platform 102. For example, first task execution system 103 may send the current task information using the first wireless data connection and via communication interface 113. Although described with respect to first task execution system 130, second task execution system 104 and/or other task execution systems may similar perform the functions below without departing from the scope of the disclosure. In some instances, enterprise user device 105 may send current task information to dynamic task resource allocation platform 102 without departing from the scope of the disclosure.

At step 208, dynamic task resource allocation platform 102 may receive the current task information. For example, dynamic task resource allocation platform 102 may receive the current task information using the first wireless data connection and via communication interface 113. For example, the current task information may include information about one or more tasks that are about to be (e.g., pending) or are currently being executed on first task execution system 103. In some instances, the current task information may include information similar to what was included in the historical task information that was received by dynamic task resource allocation platform 102 in step 203.

At step 209, dynamic task resource allocation platform 102 may preprocess the current task information. In some instances, the preprocessing may be similar to the preprocessing that was performed in step 204.

At step 210, dynamic task resource allocation platform 102 may input the preprocessed task information into the payload model to determine whether a task associated with the preprocessed task information includes a heavy payload.

Referring to FIG. 2C, at step 211, dynamic task resource allocation platform 102 may determine whether the current task information that was preprocessed contains a heavy payload.

For example, dynamic task resource allocation platform 102 may perform similar actions to what was described with reference to FIG. 4 in order to determine whether a current task associated with the current task information includes a heavy payload. For example, the CPU percentage and/or throughput may be extracted, and compared to their corresponding thresholds, and based on the CPU percentage exceeding the CPU threshold, and further based on the throughput exceeding the throughput threshold, dynamic task resource allocation platform 102 may determine that the current task contains a heavy payload. Although described with respect to both thresholds being exceeded, if only one threshold is exceeded (e.g., the throughput threshold), dynamic task resource allocation platform 102 might send a notification to enterprise user device 105, which may direct enterprise user device 105 to conduct further review/analysis. In some instances, when only one threshold is exceeded, the current task may still contain a heavy payload. In some instances, when only one threshold is exceeded, the current task might not contain a heavy payload. If the current task contains a heavy payload, then 102 may proceed to step 212. If the current task does not contain a heavy payload, then dynamic task resource allocation platform 102 may proceed to step 225.

At step 212, dynamic task resource allocation platform 102 may send commands to first task execution system 103. For example, dynamic task resource allocation platform 102 may send the commands using the first wireless data connection and via communication interface 113.

At step 213, first task execution system 103 may receive the commands. For example, first task execution system 103 may receive the commands using the first wireless data wireless and via communication interface.

In some instances, the commands may include instructions directing first task execution system 103 to preempt a current task associated with the current task information that has been identified as containing a heavy payload by the payload model 112c. For example, preempting may refer to not allowing the current task containing the heavy payload to be executed until the resource allocation associated with the current task may be updated (by, e.g., queueing the current task). Alternatively, preempting may refer to temporarily interrupting the current task if the current task has already begun to be executed.

At step 214, first task execution system 103 may preempt the task based on the commands that were received in step 213. For example, preempting the task may include queuing the task or temporarily interrupting the task. In some instances, tasks containing a heavy payload may be prioritized compared to tasks not containing a heavy payload without departing from the scope of the disclosure.

At step 215, dynamic task resource allocation platform 102 may input the preprocessed task information associated with the task that was determined to contain a heavy payload into the actuator engine 112d.

Referring to FIG. 2D, at step 216, dynamic task resource allocation platform 102 may determine an updated resource allocation using the actuator engine 112d. For example, dynamic task resource allocation platform 102 may determine an updated resource configuration by performing similar actions to what was discussed with reference to FIG. 5 (by, e.g., applying the trained actuator engine to solve the PRS algorithm to identify the updated resource allocation). For example, a current resource allocation may be extracted, then used to solve the PRS algorithm to identify the updated resource allocation. In some instances, Equation (2) and/or Equation (3) may be used to solve for one or more dependent variables (e.g., disc space, CPU cores, and/or RAM allocated), which may be associated with the updated resource configuration.

At step 217, dynamic task resource allocation platform 102 may send the updated resource allocation to first task execution system 103. For example, dynamic task resource allocation platform 102 may send the updated resource allocation using the first wireless data wireless and via communication interface 113.

At step 218, first task execution system 103 may receive the updated resource allocation. For example, first task execution system 103 may receive the updated resource allocation using the first wireless data wireless and via communication interface 113.

At step 219, first task execution system 103 dynamically reconfigure the resource allocation based on the received updated resource allocation. For example, first task execution system 103 may dynamically reconfigure the resource allocation by modifying, adapting, and/or otherwise changing the allocation of resources from the original configuration to an updated configuration based on the updated resource allocation (by e.g., changing one or more of the disc space, CPU cores, and/or RAM allocated). At step 220, first task execution system 103 may begin/resume execution of the current task after reconfiguring the resource allocation associated with the current task.

Referring to FIG. 2E, at step 221, dynamic task resource allocation platform 102 may generate a report. In some instances, the report may be similar to what is shown in FIG. 7. With reference to FIG. 7, report 705 may show an updated resource allocation for a current task being executed at a task execution system (e.g., first task execution system 103).

At step 222, dynamic task resource allocation platform 102 may establish a connection with enterprise user device 105. For example, dynamic task resource allocation platform 102 may establish a second wireless data connection with enterprise user device 105 to link dynamic task resource allocation platform 102 to enterprise user device 105 (e.g., in preparation for sending the report). In some instances, dynamic task resource allocation platform 102 may identify whether or not a connection is established with enterprise user device 105. If a connection is already established with enterprise user device 105, dynamic task resource allocation platform 102 might not re-establish the connection. If a connection is not yet with enterprise user device 105, dynamic task resource allocation platform 102 may establish the second wireless data connection as described herein.

At step 223, dynamic task resource allocation platform 102 may send the report. For example, dynamic task resource allocation platform 102 may send the report using the second wireless data wireless and via communication interface 113. In some instances, dynamic task resource allocation platform 102 may also send commands directing enterprise user device 105 to display the repot.

At step 224, enterprise user device may receive the report and the commands directing enterprise use device 105 to display the report. For example, enterprise user device 105 may receive the report and the commands using the second wireless data wireless and via communication interface 113.

At step 225, enterprise user device 105 may, in response to receiving the report and the commands, display the report (e.g., displaying what is shown in FIG. 7).

Referring to FIG. 2F, at step 226, dynamic task resource allocation platform 102 may dynamically update the payload model 112c. In some instances, dynamic task resource allocation platform 102 may dynamically update the payload model 112c based on the actions performed in steps 204-211, and/or feedback from first task execution system 103, second task execution system 104, and/or enterprise user device 105. In doing so, dynamic task resource allocation platform 102 may dynamically and continuously update (e.g., using a dynamic feedback loop) and/or otherwise refine the payload model 112c so as to increase accuracy of the payload model 112c over time. For example, dynamic task resource allocation platform 102 may update the payload model 112c by varying the thresholds (e.g., the CPU threshold and/or the throughput threshold) in order to more accurately determine whether a task includes a heavy payload.

At step 227, dynamic task resource allocation platform 102 may dynamically update the actuator engine 112d. In some instances, dynamic task resource allocation platform 102 may dynamically update the actuator engine 112d based on the actions performed in steps 204-211, and/or feedback from first task execution system 103, second task execution system 104, and/or enterprise user device 105. In doing so, dynamic task resource allocation platform 102 may dynamically and continuously update (e.g., using a dynamic feedback loop) and/or otherwise refine the actuator engine 112d so as to increase accuracy of the actuator engine 112d over time. For example, dynamic task resource allocation platform 102 may dynamically update the actuator engine 112d similar to what was described with reference to FIG. 6, and/or by updating the accuracy threshold.

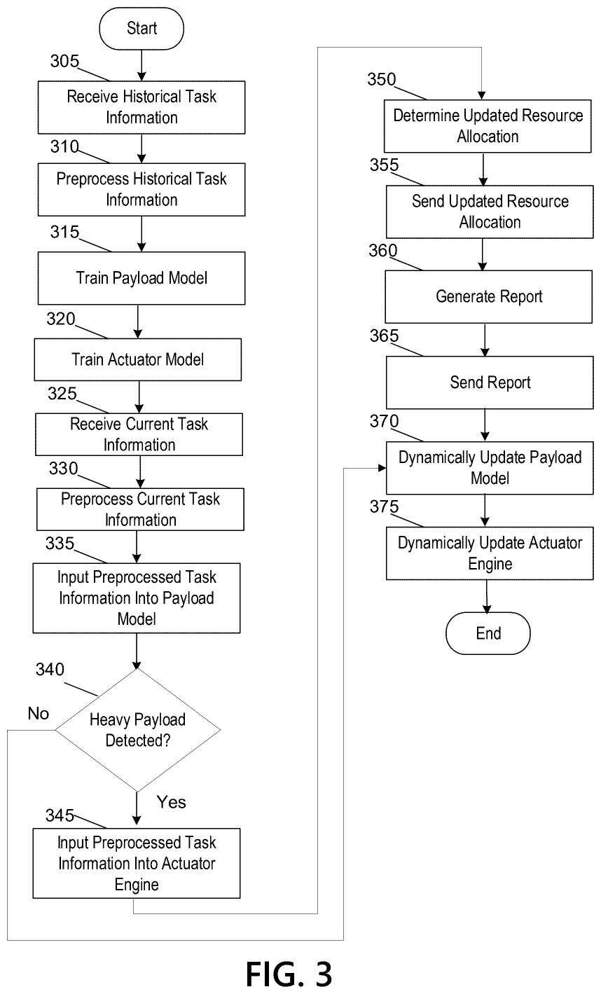

FIG. 3 depicts an illustrative method for implementing dynamic resource allocation in accordance with one or more aspects described herein. At step 305, a computing platform having at least one processor, a communication interface, and memory may receive historical task information. At step 310, the computing platform may preprocess the historical task information.

At step 315, the computing platform may train a payload model (e.g., payload model 112c). At step 320, the computing platform may train an actuator engine (e.g., actuator engine 112d).

At step 325, the computing platform may receive current task information. At step 330, the computing platform may preprocess the current task information. At step 335, the computing platform may input the preprocessed task information into the trained payload model.

At step 340, the computing platform may determine whether a task associated with the preprocessed task information contains a heavy payload. If a heavy payload is detected, the computing platform may proceed to step 345. If a heavy payload is not detected, the computing platform may proceed to step 370.

At step 345, the computing platform may input the preprocessed task information into the trained actuator engine. At step 350, the computing platform may determine updated resource allocation using the trained actuator engine.

At step 355, the computing platform may send the updated resource allocation (to, e.g., first task execution system 103). At step 360, the computing platform may generate a report. At step 365, the computing platform may send the report.

At step 370, the computing platform may dynamically update the payload model. At step 375, the computing platform may dynamically update the actuator engine.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, based on historical task information, a payload model, wherein training the payload model configures the payload model to identify whether a task includes a heavy payload;
receive, from a task execution system, first task information corresponding to a first task;
preprocess the first task information;
input the preprocessed first task information into the trained payload model;
extract a central processing unit (CPU) percentage and a throughput in the preprocessed first task information corresponding to the first task;
compare the CPU percentage to a CPU percentage threshold;
compare the throughput to a throughput threshold; and
based on identifying that both the CPU percentage threshold and the throughput threshold being exceeded, send commands to the task execution system, that when received, direct the task execution system to preempt the first task, wherein the preempting comprises one of:
queuing the first task; or
interrupting the first task.

2. The computing platform of claim 1, wherein the preprocessing further comprises using a raw zone, a stage zone, and a hub zone to preprocess the first task information.

3. The computing platform of claim 1, wherein the memory stores additional computer-readable instructions that, when executed by the at least one processor, cause the computing platform to:
update the payload model using a dynamic feedback loop and based on one or more of: the extracting, the comparing the CPU percentage to the CPU percentage threshold, or the comparing the throughput to the throughput threshold, the payload model.

4. The computing platform of claim 1, wherein the payload model is a Naïve Bayes classification model.

5. The computing platform of claim 1, wherein the training further comprises:
generating a frequency table, wherein the frequency table comprises the historical task information that was used to train the payload model; and
generating a likelihood table, wherein the likelihood table comprises a classifier and threshold information.

6. The computing platform of claim 1, wherein the memory stores additional computer-readable instructions that, when executed by the at least one processor, cause the computing platform to:
based on the CPU percentage threshold or the throughput threshold being exceeded:
send an indication, that when received by an enterprise user device, notifies the enterprise user device that one or more of the CPU percentage threshold or the throughput threshold has been exceeded.

7. The computing platform of claim 1, wherein the memory stores additional computer-readable instructions that, when executed by the at least one processor, cause the computing platform to:
input, into an actuator engine, the first task information associated with the first task that contains a heavy payload.

8. The computing platform of claim 7, wherein the memory stores additional computer-readable instructions that, when executed by the at least one processor, cause the computing platform to:
use the actuator engine to identify an updated resource allocation associated with the first task.

9. The computing platform of claim 8, wherein the memory stores additional computer-readable instructions that, when executed by the at least one processor, cause the computing platform to:
generate a report, wherein the report comprises the updated resource allocation and the first task information.

10. The computing platform of claim 9, wherein the memory stores additional computer-readable instructions that, when executed by the at least one processor, cause the computing platform to:
send, to an enterprise user device, the report and one or more commands directing the enterprise user device to display the report, wherein sending the one or more commands directing the enterprise user device to display the report causes the enterprise user device to display the report.

11. A method comprising:
at a computing platform comprising at least one processor, a communication interface, and memory:
training, based on historical task information, a payload model, wherein training the payload model configures the payload model to identify whether a task includes a heavy payload;
receiving, from a task execution system, first task information corresponding to a first task;
preprocessing the first task information;
inputting the preprocessed first task information into the trained payload model;
extracting a central processing unit (CPU) percentage and throughput in the preprocessed first task information corresponding to the first task;
comparing the CPU percentage to a CPU percentage threshold;
comparing the throughput to a throughput threshold; and
based on identifying that both the CPU percentage threshold and the throughput threshold being exceeded, sending commands to the task execution system, that when received, direct the task execution system to preempt the first task, wherein the preempting comprises one of:
queuing the first task; or
interrupting the first task.

12. The method of claim 11, wherein the preprocessing further comprises using a raw zone, a stage zone, and a hub zone to preprocess the first task information.

13. The method of claim 11, further comprising:
updating the payload model using a dynamic feedback loop and based on one or more of: the extracting, the comparing the CPU percentage to the CPU percentage threshold, or the comparing the throughput to the throughput threshold, the payload model.

14. The method of claim 11, wherein the payload model is a Naïve Bayes classification model.

15. The method of claim 11, wherein the training further comprises:
generating a frequency table, wherein the frequency table comprises the historical task information that was used to train the payload model; and
generating a likelihood table, wherein the likelihood table comprises a classifier and threshold information.

16. The method of claim 11, further comprising:
based on the CPU percentage threshold or the throughput threshold being exceeded:
sending an indication, that when received by an enterprise user device, notifies the enterprise user device that one or more of the CPU percentage threshold or the throughput threshold has been exceeded.

17. The method of claim 11, further comprising:
inputting, into an actuator engine, the first task information associated with the first task that contains a heavy payload.

18. The method of claim 17, further comprising:
using the actuator engine to identify an updated resource allocation associated with the first task.

19. The method of claim 18, further comprising:
generating a report, wherein the report comprises the updated resource allocation and the first task information; and
sending, to an enterprise user device, the report and one or more commands directing the enterprise user device to display the report, wherein sending the one or more commands directing the enterprise user device to display the report causes the enterprise user device to display the report.

20. One or more non-transitory computer-readable storing instructions that, when executed by a computing platform comprising at least one processor, a communication interface, and memory, cause the computing platform to:
train, based on historical task information, a payload model, wherein training the payload model configures the payload model to identify whether a task includes a heavy payload;
receive, from a task execution system, first task information corresponding to a first task;
preprocess the first task information;
input the preprocessed first task information into the trained payload model;
extract a central processing unit (CPU) percentage and throughput in the preprocessed first task information corresponding to the first task;
compare the CPU percentage to a CPU percentage threshold;
compare the throughput to a throughput threshold; and
based on identifying that both the CPU percentage threshold and the throughput threshold being exceeded, send commands to the task execution system, that when received, direct the task execution system to preempt the first task, wherein the preempting comprises one of:
queuing the first task; or
interrupting the first task.
